(19) United States
(12) Patent Application Publication
(10) Pub. No.: US 2026/0313427 A1
(43) Pub. Date: Oct. 8, 2026

(54) METHOD AND APPARATUS FOR MANAGING INFORMATION PROCESSING UNIT FOR INTELLIGENT CHANNEL INFORMATION REPORTING IN MOBILE COMMUNICATION SYSTEM

(71) Applicant: ELECTRONICS AND TELECOMMUNICATIONS RESEARCH INSTITUTE, Daejeon (KR)

(72) Inventors: Yong Jin KWON, Daejeon (KR); Seungjae BAHNG, Daejeon (KR); Youngjoon YOON, Daejeon (KR); Anseok LEE, Daejeon (KR); Heesoo LEE, Daejeon (KR); Yunjoo KIM, Daejeon (KR); Hyun Seo PARK, Daejeon (KR); Jungsook BAE, Daejeon (KR); Jungbo SON, Daejeon (KR); Yu Ro LEE, Daejeon (KR)

(73) Assignee: ELECTRONICS AND TELECOMMUNICATIONS RESEARCH INSTITUTE, Daejeon (KR)

(21) Appl. No.: 19/578,763

(22) Filed: Mar. 25, 2026

(30) Foreign Application Priority Data
Mar. 28, 2025 (KR) 10-2025-0040346
Apr. 29, 2025 (KR) 10-2025-0056181
Nov. 20, 2025 (KR) 10-2025-0176753

(51) Int. Cl. H04W 24/10; H04W 8/24; H04W 72/0446

(52) U.S. Cl. CPC H04W 24/10; H04W 8/24; H04W 72/0446

(57) ABSTRACT

The present disclosure proposes a method and an apparatus for managing information processing units for intelligent channel information reporting in a mobile communication system. For example, the present disclosure proposes a method and an apparatus for managing channel information processing units of a terminal when the terminal reports channel information using an intelligent function in a mobile communication system including a base station and one or more terminals. In addition, a method for allocating channel information processing units for intelligent channel information reporting and a method for using computation time are proposed. Further, a priority rule for intelligent channel information reporting is proposed.

### CROSS-REFERENCE TO RELATED APPLICATIONS

This application claims priority to Korean Patent Applications No. 10-2025-0040346, filed on Mar. 28, 2025, No. 10-2025-0056181, filed on Apr. 29, 2025, and No. 10-2025-0176753, filed on Nov. 20, 2025, with the Korean Intellectual Property Office (KIPO), the entire contents of which are hereby incorporated by reference.

### BACKGROUND

### 1. Technical Field

The present disclosure relates to mobile communication, and more particularly, to a method and apparatus for managing information processing units for intelligent channel information reporting in a mobile communication system.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Such a communication system may be designed in consideration of various scenarios, service requirements, potential system compatibility, and the like. In particular, in a 5G NR communication system, discussions on beam-based communication may be active in order to perform broadband communication in high frequency bands. Accordingly, beam-based communication may continue to be used. In addition, a communication system may improve performance by using artificial intelligence (AI)/machine learning (ML).

The 3GPP, which is an international standardization organization, discusses application schemes of intelligent technologies (or AI/ML models) for an air interface, establishes use cases for applying intelligent technologies to the air interface, and discusses specification work required for each use case when the intelligent technologies are used. Here, beam management, positioning accuracy enhancement, Channel State Information (CSI) feedback enhancement, and the like may be considered as representative use cases.

Hereinafter, life cycle management of AI/ML models (or intelligent functionalities/models) will be described.

Since an intelligent technology is based on training data, life cycle management (hereinafter, LCM) for generation and maintenance of intelligent functionalities or models due to changes in training data needs to be performed. Accordingly, when a function based on an intelligent technology is to be applied in a mobile communication system composed of a base station and/or a terminal, such as the use cases described above, the mobile communication system needs to be capable of supporting LCM. In this regard, as detailed steps for LCM, data collection, model training, model inference, model deployment, model activation, model deactivation, model selection, model switching, model fallback, model monitoring, and the like are considered. For example, in a mobile communication system, a specific intelligent model may be generated through a model training process based on data collection, and after model deployment and model activation process are performed, an intelligent model-based operation may be performed through a model inference process using a model, and the model may be managed through a model monitoring process.

In addition, in the present disclosure, for convenience of description, types of AI/ML models may be classified as follows according to the location of a network node in which model inference of an AI/ML model is performed.
Model type 1: one-sided AI/ML model

This type of model may correspond to an AI/ML model in which inference is performed entirely at a terminal (or user equipment (UE)) or in a network. Here, the model may be classified into a UE-sided AI/ML model when inference is performed entirely in a terminal, and a network-sided AI/ML model when inference is performed only in a network.
Model type 2: two-sided AI/ML model

This type of model may correspond to paired AI/ML models in which joint inference is performed. Here, joint inference may include AI/ML inference in which inference is jointly performed across a terminal and a network.

For example, when a first part of inference is performed by a terminal (i.e. UE-part of the two-sided model) and a remaining part is performed by a base station (i.e. NW-part of the two-sided model), or vice versa, this model may correspond to a two-sided AI/ML model.

Before using an intelligent functionality and a model in a mobile communication system and performing LCM, functionality identification and model identification supported by the network should first be performed. For example, a base station identifies which intelligent functionalities and models a terminal is capable of supporting, and based on the identified intelligent functionalities and models, the base station may instruct activation of a specific intelligent functionality and model in the terminal. With respect to identification of such an intelligent functionality and model, the following two LCM directions are discussed.
Functionality-based LCM
Model-identifier (ID)-based LCM

The model-ID based LCM may mean an LCM process in which a base station (or a base station-side server) and a terminal (or a terminal-side server) share intelligent model information together with a model-ID in advance, and thereafter the base station and the terminal identify and manage an intelligent model through the model-ID or the like. The functionality-based LCM may mean an LCM process in which a base station (or a base station-side server) and a terminal (or a terminal-side server) share functionality information related to an intelligent functionality in advance, and thereafter the base station and the terminal identify and manage an intelligent functionality using a functionality name or a functionality ID. Here, the two LCM approaches may be configured independently, or may be configured in a mixed form.

Hereinafter, intelligent beam management or A/ML-based beam management will be described.

FIG. 1 is a conceptual diagram for describing intelligent beam management or AI/M-based beam management.

Referring to FIG. 1, as a frequency band used in a cellular mobile communication system increases, a millimeter wave (mmWave) band (e.g. 30 GHz to 300 GHz) may be used. When a high frequency band is used, a wavelength becomes shorter and path attenuation becomes severe, and thus a propagation distance of a signal decreases. As a method for addressing this problem, antenna technology may be used to generate a directional beam directing a signal toward a specific region in order to improve the propagation distance. A transmission power of a signal transmitted by a base station beam is generally inversely proportional to a width or an area covered by the base station beam. Accordingly, in order to overcome deterioration of received signal quality in a high frequency band, a base station may form a plurality of transmission beams to cover an entire cell area. Each base station beam provides coverage for a region narrower than an entire coverage area but provides transmission power amplification sufficient to overcome higher signal propagation loss. Here, when such directional beams are used, in order to guarantee stable link performance, a process of selecting a base station beam (or transmission beam) and a terminal beam (or reception beam) that provide optimal performance between the base station and the terminal among a plurality of beams may be required. For selecting an optimal beam, a method of obtaining measurement results for all available beams, a method of performing measurement for a plurality of beams and selecting an optimal beam according to an implementation of the base station or the terminal, and the like may be considered. However, in a process of finding an optimal beam in this manner, overhead occurs, and frequent overhead may cause performance degradation and increased terminal power consumption.

Accordingly, the introduction of intelligent technologies into a beam management process is being considered. A beam management technology using an intelligent technology may reduce overhead used in existing beam measurements while maintaining accuracy. In beam management based on AI/ML or intelligent technology, beam prediction, which is a use case for predicting a beam of a resource not observed in a spatial domain or a temporal domain by applying an intelligent technology, is discussed.

Hereinafter, intelligent positioning accuracy enhancement or A/ML-based positioning accuracy enhancement will be described.

FIG. 2 is a conceptual diagram for describing intelligent positioning accuracy enhancement or AI/ML-based positioning accuracy enhancement.

Positioning refers to a technique for measuring a location of a specific terminal in a mobile communication system, and 5G NR supports a scheme in which a terminal measures and reports a reference signal time difference (RSTD) based on positioning reference signals (PRS), and a positioning technique such as observed time difference of arrival (OTDOA) is applied based on the reported RSTD. Recently, requirements for indoor positioning accuracy are increasing, and technologies for improving accuracy of measurement values for positioning by applying an intelligent technology are being discussed. In intelligent technology-based positioning, AI/ML assisted positioning, which is a use case for improving accuracy of a conventional positioning technique by applying an intelligent technology, and direct AI/ML positioning, which is a use case for directly estimating a location of a terminal by applying an intelligent technology, are discussed.

Hereinafter, intelligent channel information feedback enhancement or AI/Mb-based CSI feedback enhancement will be described.

CSI feedback means that a terminal reports CSI in order to support application of transmission techniques such as multiple input multiple output (MIMO) or precoding by a base station in a mobile communication system. 5G NR supports feedback information such as channel quality indicator (CQI), precoding matrix indicator (PMI), and rank indicator (RI) with respect to a channel information feedback scheme. In an NR system, discussions on methods for improving CSI feedback techniques are ongoing in order to effectively support transmission techniques such as multi-user MIMO (MU-MIMO).

As one research direction for applying intelligent technology to channel information feedback, discussions on CSI compression technology for obtaining a compressed latent representation of a MIMO channel using an auto-encoder are ongoing.

FIG. 3 is a conceptual diagram for describing an example structure of an auto-encoder.

Referring to FIG. 3, an auto-encoder refers to a neural network structure that reproduces an input at an output, and the auto-encoder is characterized in that data compression or dimensionality reduction is achieved by setting the number of neurons in a hidden layer between an encoder and a decoder to be smaller than the number of neurons in an input layer.

### SUMMARY

The present disclosure proposes a method and an apparatus for managing channel state information processing units of a terminal when the terminal reports channel information using an intelligent functionality in a mobile communication system composed of a base station and one or more terminals. For example, methods for allocating a channel state information processing unit for intelligent channel information reporting and a method for using a computation time are proposed. In addition, a priority rule for intelligent channel information reporting is proposed.

When a method for managing a channel state information processing unit for intelligent channel information reporting proposed through the present disclosure is used, intelligent channel information reporting can be performed differently depending on the performance of a terminal. Accordingly, unnecessary channel information reporting can be reduced, and performance can be improved by efficiently using resources of the terminal.

### BRIEF DESCRIPTION OF DRAWINGS

FIG. 1 is a conceptual diagram for describing intelligent beam management or ALI/M-based beam management.

FIG. 2 is a conceptual diagram for describing intelligent positioning accuracy enhancement or ALI/M-based positioning accuracy enhancement.

FIG. 3 is a conceptual diagram for describing an example structure of an auto-encoder.

FIG. 4 is a conceptual diagram for describing an example of intelligent beam management.

FIG. 5 is a conceptual diagram for describing an example of operations required when an intelligent model is located at a terminal side.

FIG. 6 is a conceptual diagram for describing an example of operations required when an intelligent model is located at a network side.

FIG. 7 is a conceptual diagram for describing use cases of intelligent beam prediction.

FIG. 8 is a conceptual diagram for describing an example to which Proposed Method 03 according to an exemplary embodiment of the present disclosure is applied.

FIG. 9 is a flow chart for describing an example of operations performed by a terminal according to an exemplary embodiment of the present disclosure.

FIG. 10 is a conceptual diagram for describing a first exemplary embodiment of a mobile communication system.

FIG. 11 is a block diagram for describing a first exemplary embodiment of a communication node constituting a communication system.

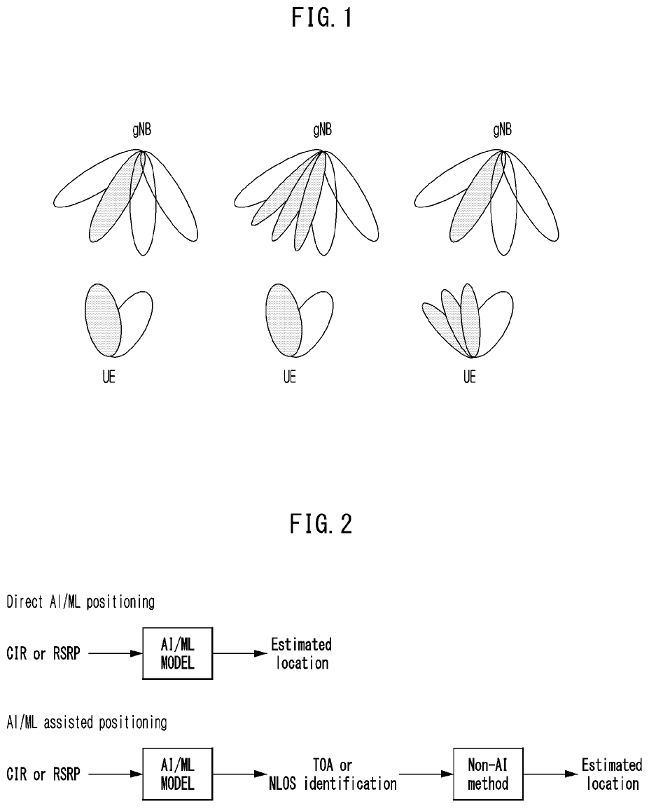

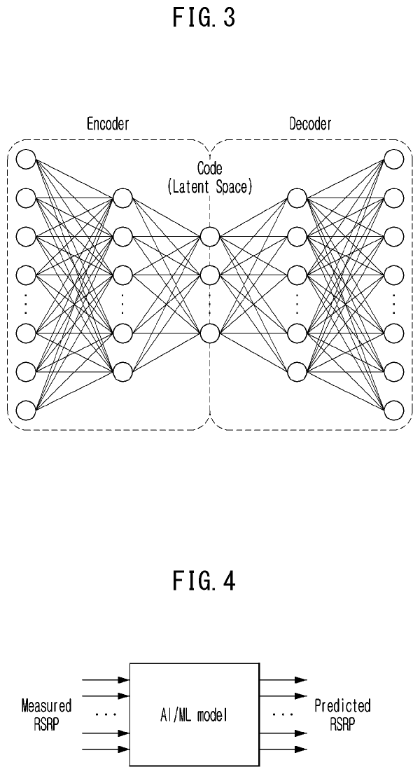

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may mean “at least one of A or B” or “at least one among one or more combinations of A and B”. In addition, in exemplary embodiments of the present disclosure, “one or more of A and B” may mean “one or more of A or B” or “one or more among one or more combinations of A and B”.

In exemplary embodiments of the present disclosure, “(re)transmission” may mean “transmission”, “retransmission”, or “transmission and retransmission,” “(re)configuration” may mean “configuration”, “reconfiguration”, or “configuration and reconfiguration”, “(re)connection” may mean “connection”, “reconnection”, or “connection and reconnection”, and “(re)access” may mean “access”, “reaccess”, or “access and reaccess”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, beyond 5G (B5G) mobile communication network (e.g. 6G mobile communication network), or the like.

Throughout the present disclosure, a terminal may refer to an access terminal, mobile station, mobile terminal, station, subscriber station, portable subscriber station, user equipment, node, device, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present disclosure, a base station may refer to a node B (NodeB), evolved node B (eNB), base transceiver station (BTS), radio base station, radio transceiver, access point, access node, road side unit (RSU), digital unit (DU), cloud digital unit (CDU), radio remote head (RRH), radio unit (RU), transmission point (TP), transmission and reception point (TRP), relay node, or the like.

Hereinafter, exemplary embodiments according to the present disclosure will be described with reference to a 3GPP NR mobile communication system, and prior documents defining operations of the 3GPP NR mobile communication system may also be referenced. Names of specific devices or specific signals/messages/fields described in the drawings are presented merely as examples, and thus technical features of the present disclosure are not limited to the specific names used in the drawings below.

Hereinafter, for convenience of description, a method and an apparatus for managing a channel state information processing unit for intelligent channel information reporting proposed in the present disclosure are mainly described from a downlink perspective of a wireless mobile communication system composed of a base station and a terminal, but the proposed schemes of the present disclosure may be extended to and applied to any wireless mobile communication system composed of a transmitter and a receiver. In addition, hereinafter, the present disclosure is described from the perspective of use cases discussed in the 5G NR specifications, such as an intelligent channel feedback enhancement method, an intelligent beam management method, and an intelligent positioning enhancement method, but the proposed schemes of the present disclosure may be extended to and applied to other intelligent use cases.

When model-ID based life cycle management (LCM) is used, a process referred to as model identification is required for identifying an AI/ML model. Currently, with respect to model identification, the following three possibilities are being discussed. A Type A scheme is a method in which a base station or a base station-side server and a terminal or a terminal-side server perform model identification in a manner not visible in the technical specifications. A Type B1 scheme is a method in which a terminal transmits an AI/ML model trained by the terminal to a network using a signal predefined in the technical specifications and performs a model identification process. Conversely, a Type B2 scheme is a method in which a base station transmits an AI/ML model trained by the base station to a terminal and performs a model identification process.
Type A: offline-based model identification without over-the-air (OTA) signaling.
Type B1: model identification initiated by a terminal using OTA signaling.
Type B2: model identification initiated by a network using OTA signaling.

In a process in which model identification is performed, a model-ID is assigned, and in that process, additional information required to be shared between a terminal and a base station (e.g. meta information) may be shared together. Examples of the meta information may include information regarding an input and/or an output of an intelligent model, information related to complexity of the intelligent model, and information regarding the applicable conditions of the corresponding model.

Model delivery refers to delivery of an AI/ML model from one entity to another entity using any method. Here, an entity may be a node or a function (e.g. a gNB or a Location Management Function (LMF)) in a network, a terminal (user equipment (UE)), or a proprietary server (e.g. an Over-The-Top (OTT) server). In addition, model transfer refers to delivering a new AI/ML model or delivering parameters of an already known model through a method perceivable via an OTA interface (i.e. not transparent to the OTA interface).

With respect to LCM schemes, recently, a method is being discussed in which a functionality-based LCM method is used as a baseline, and a model-based LCM method is used only in a specific situation or some functions such as a model-ID are integrated into functionality-based LCM.

In the case of model-ID based LCM, representative examples currently under discussion include a scheme for pairing operations between a terminal and a base station in use cases using a two-sided AI/ML model (e.g. CSI compression in channel feedback enhancement), and a scheme in which a specific AI/ML model is transferred from a network to a terminal or conversely from a terminal to a network using model transfer.

FIG. 4 is a conceptual diagram for describing an example of intelligent beam management.

In an inference process using an intelligent beam management technology, a process of measuring performance of a specific beam may be required to select an optimal beam. For example, performance may include layer-1 reference signal received power (L1-RSRP) or layer-1 signal to interference plus noise ratio (L1-SINR) measured by a terminal. Performance of a measured beam may be provided as input to an intelligent model (i.e. AI/ML model) and may be used to obtain an output or a result in an inference process. A result value of the intelligent model may include an index of a beam having optimal performance and predicted performance of all available beams (e.g. L1-RSRP). In a beam performance measurement process, it is important to determine base station beam(s) or beam pair(s) each including both a base station beam and a terminal beam used to perform performance measurement. When an exhaustive search method that obtains measurement results for all base station beams or beam pairs is used, a base station beam or a beam pair providing optimal performance may be determined in any situation, but overhead may occur in the measurement process. In general, a resource used in a beam performance measurement process is a synchronization signal block (SSB) or a channel state information-reference signal (CSI-RS), and beam performance measurement may be performed by transmitting a predefined reference signal (RS). In order to balance between overhead of a measurement process and performance using a beam finally selected, it may be required to reduce performance measurement for unnecessary beams. An intelligent model for beam selection may independently exist at a base station or a terminal. When an intelligent model is located at a base station, an additional process of transmitting beam performance information measured by a terminal to the base station and using the beam performance information as an input of the intelligent model may be required. When an intelligent model is located at a terminal, a process of transmitting a result output from the intelligent model, that is, an inference report, to a base station may be required.

An intelligent model performing an intelligent beam management technology may be located at a terminal side (i.e. UE-side) or at a network side (i.e. NW-side). According to a location of an intelligent model, operations to be performed by the base station and the terminal to support an intelligent beam management technology may be different. Operations required for intelligent beam management operations may include LCM operations such as data collection for training, inference, and model monitoring (performance monitoring). In the present disclosure, a term ‘model monitoring’ has a purpose of measuring performance of an intelligent model, and thus the term ‘model monitoring’ may be interchangeably used with a term ‘performance monitoring’.

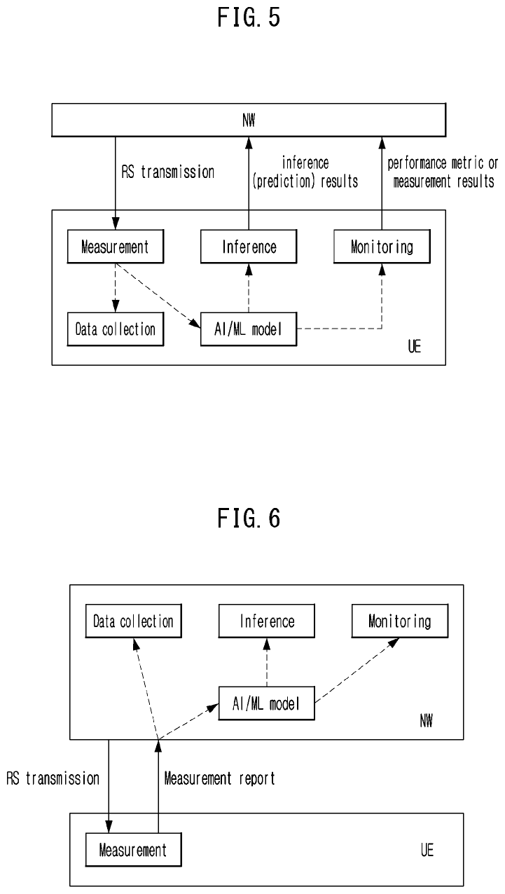

FIG. 5 is a conceptual diagram for describing an example of operations required when an intelligent model is located at a terminal side.

For operations of an intelligent beam management technology, it is essential that a base station transmits a reference signal for beam measurement and a terminal measures the reference signal. When an intelligent model is located at a terminal side, the terminal is an entity performing measurement, and thus the terminal may not transmit beam measurement results to the base station in a data collection process for training and in an inference process. However, even when the terminal does not transmit measurement results in the inference process, the terminal may transmit a result predicted using the intelligent model to the base station. In addition, when a model monitoring operation is performed, calculation of a performance metric may be required. When the terminal performs calculation of a performance metric, the terminal may calculate a performance metric based on measurement results. In addition, a process of transmitting the performance metric calculated by the terminal to the base station may be required. When calculation of a performance metric is performed in a network, it may be necessary for the terminal to transmit beam measurement information required for performance metric calculation and output information from the intelligent model to the base station.

FIG. 6 is a conceptual diagram for describing an example of operations required when an intelligent model is located at a network side.

When an intelligent model is located at a network side, a terminal may report or transmit measurement results to a base station with respect to reference signals transmitted by the base station. The base station may receive a measurement report from the terminal and may use the measurement report in a data collection process for training or in an inference process. In addition, calculation of a performance metric for performing a model monitoring operation may be performed at the base station. For this purpose, when measurement information from the terminal is required, the terminal may transmit corresponding information to the base station.

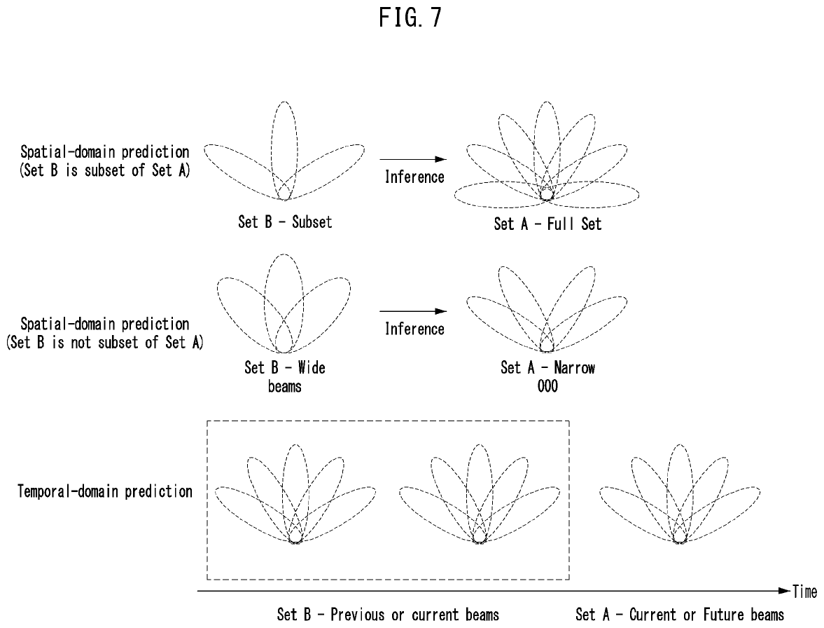

FIG. 7 is a conceptual diagram for describing use cases of intelligent beam prediction.

Referring to FIG. 7, an intelligent beam management technology may be classified into spatial-domain beam prediction, which is referred to as BM-case1 in the present disclosure, and temporal-domain beam prediction, which is referred to as BM-case2 in the present disclosure. The spatial-domain beam prediction corresponds to a method of selecting an optimal beam for a specific time using beam performance results measured at a specific time. The spatial-domain beam prediction may be subdivided into two cases according to a relationship between Set B, which is a set of beams measured in an inference process used as an input to an intelligent model, and Set A, which is an output of the intelligent model and is a full set of beams that may be predicted. In a first case, Set B is a subset of Set A, and beams of Set B used in an inference process may be composed of a part of a full set of available beams. In a second case, Set B is not a subset of Set A. As a representative example, Set B may have a form of wide beams such as SSB, and Set A may have a form of narrow beams such as CSI-RS. In other words, measurement results of wide beams are used as an input of an intelligent model, and a narrow beam is predicted and output by the intelligent model. The temporal-domain beam prediction corresponds to a method of selecting an optimal beam at a current time or a future time using beam performance results measured at current and past times. In the temporal-domain beam prediction, since an intelligent model may predict optimal beams at multiple times, one CSI report may include inference results for one or more future times.

Hereinafter, proposed methods of the present disclosure will be described in more detail.

### [Proposed Method 01]

CSI processing units (CPUs) related to CSI reporting of a terminal may be defined. A base station may instruct CSI reporting in consideration of an amount of channel information that may be simultaneously processed for CSI reporting of the terminal, that is, channel information processing capability of the terminal. A number of CSI processing units that the terminal may simultaneously use may be defined as N_{cpu}. The terminal may not expect a CSI reporting instruction from the base station that requires channel information calculation exceeding N_{cpu} or may not consider update of the corresponding CSI. The terminal may report N_{CPU} to the base station through higher-layer signaling such as RRC signaling, or the base station may configure N_{cpu} for the terminal through higher-layer signaling. For example, when a number of CPUs required for the respective CSI reports n (n=0, 1, . . . , N−1) is defined as

$${O}_{cpu}^{( n )} ,$$

a number of CPUs required for total N CSI reports may be expressed as

$${\sum }_{n} {O}_{cpu}^{( n )} .$$

When L CPUs are already occupied at a specific time at the terminal, the terminal may have unoccupied CPUs corresponding to a difference between N_{cpu} and L at the specific time.

When the terminal does not have sufficient available CPUs to process all CSI reports at a specific time when performing CSI reporting, the terminal may not update one or more low-priority CSI reports. Among a plurality of instructed CSI reports, CSI report(s) for which update of channel information is not considered may be determined in consideration of at least one of a time during which channel information calculation required for CSI reporting occupies CPUs and importance of reported channel information or a CSI priority rule. For example, the base station or the terminal may not consider update of channel information for CSI report(s) for which channel information calculation required for CSI reporting starts at the latest time among CPU occupation times, or may not consider update of channel information for CSI reports having low CSI priority of channel information.

In a case of CSI reporting involving an intelligent operation or an operation using an AI/ML model, separate CPU management for intelligent CSI reporting may be required in addition to the aforementioned CPU management method. In order to perform an inference operation for generating an intelligent CSI report, hardware such as a graphics processing unit (GPU), which is not used in a legacy CSI reporting process, may be required. Accordingly, a number of intelligent CSI reports that may be simultaneously generated may differ according to performance of the terminal, and thus a scheme for managing a plurality of intelligent CSI reports is required. Hereinafter, a CPU using an AI/ML model is referred to as an intelligent CPU (CPU_{AIML}).

A CPU used in a legacy CSI reporting process and an intelligent CPU (i.e. CPU_{AIML}) used in a CSI reporting process of an intelligent operation may operate completely separately. For example, a number of intelligent CPUs that the terminal may support for intelligent operations may be separately configured as N_{cpu,AIML}, and a number of processing units required for an n-th CSI report requiring an intelligent operation may be expressed as

$${O}_{cpu , AIML}^{( n )} .$$

Accordingly, a number of intelligent CPUs (i.e. CPU_{AIML}) required to perform total N intelligent CSI reports may be calculated as

$${\sum }_{n} {O}_{cpu , AIML}^{( n )} .$$

When the terminal does not have sufficiently available intelligent CPUs (i.e. CPU_{AIML}) to process all intelligent CSI reports at a specific time when performing intelligent CSI reporting, the terminal may not update one or more low-priority intelligent CSI reports. Among a plurality of instructed intelligent CSI reports, CSI report(s) for which update of channel information is not considered may be determined in consideration of at least one of a time during which channel information calculation required for CSI reporting occupies CPU_{AIM} resources, importance of reported channel information, or an intelligent CSI priority rule.

In this case, even when the operating intelligent functions correspond to different functionalities, the intelligent functions may be integrated and managed by one intelligent CPU (i.e. CPU_{AIML}). For example, intelligent CSI reporting performed in a CSI prediction use case and in an intelligent beam management use case may be integrated and managed by one intelligent CPU (i.e. CPU_{AIML}).

In a beam management use case, detailed processes of legacy CSI reporting may be configured as follows. For example, processes may include performing channel estimation based on a reference signal received by the terminal, calculating L1-RSRP, and preparing the L1-RSRP in the form of UCI for uplink reporting. Here, the aforementioned CPU may represent a processing capacity of the terminal. For an intelligent operation, in addition to the aforementioned detailed processes, an operation of performing inference using an intelligent model may be added to the detailed processes. Accordingly, when an intelligent CPU (CPU_{AIML}) operates independently from a legacy CPU, the intelligent CPU may mean a capacity of the terminal to process operations such as channel estimation, L1-RSRP calculation, UCI generation/preparation, and inference of an intelligent model.

As another method of using an intelligent CPU (CPU_{AIML}), a method may be considered in which an intelligent CPU CPU_{AIML} is configured as a subset within a legacy CSI reporting CPU operation. In this case, for the terminal, a CSI reporting process may be performed to simultaneously satisfy two conditions, that is, the number of legacy CPUs Nep and the number of intelligent CPUs N_{cpu,AIML}. In other words, when performing intelligent CSI reporting, if a terminal does not have sufficiently available CPUs and intelligent CPUs to process all intelligent CSI reports at a specific time, the terminal may not update one or more low-priority intelligent CSI reports. In this case, a legacy CPU may mean a processing capacity of the terminal used for legacy detailed operations such as channel estimation, L1-RSRP calculation, and UCI preparation required in a legacy CSI reporting process, and an intelligent CPU may mean a processing capacity of the terminal that may be used for an inference operation of an intelligent model newly added for an intelligent operation.

The above Proposed Method 01 may be applied together with other proposed method(s) of the present disclosure within a range that does not conflict with the other proposed method(s).

### [Proposed Method 02]

When using the aforementioned CPU_{AIML}-related schemes for intelligent CSI reporting, a number of processing units required for each intelligent CSI report may be defined as O_{cpu,AIML}. The value of O_{cpu,AIML} may change according to which channel information is to be updated in each intelligent CSI reporting process. For example, when performing an inference operation or a performance monitoring operation for spatial-domain beam prediction (i.e. BM-case1) in an intelligent beam management use case, the terminal performs an intelligent operation only for a single time point, and thus O_{cpu,AIML} may be defined as 1.

In addition, when performing an inference operation or performance monitoring for temporal-domain beam prediction (i.e. BM-case2) in an intelligent beam management use case, the terminal performs an intelligent operation for multiple time points, and thus O_{cpu,AIML} may have a value greater than 1. First, O_{cpu,AIML} may be proportional to N, which is a number of time instances to be predicted. For example, N may have a value such as 1, 2, 4, or 8. In a case of time-series beam prediction, complexity of an intelligent model used by the terminal may differ according to the terminal, and thus an additional variable Y may be considered when calculating O_{cpu,AIML}. For example, Y may have a value such as 1, 2, or 3 according to complexity of a model used by the terminal. The terminal may transmit a corresponding Y value to the base station through a UE capability report. Consequently, a number of processing units O_{cpu,AIML} for corresponding intelligent CSI reporting may be expressed in the form of N multiplied by Y.

The above Proposed Method 02 may be applied together with other proposed method(s) of the present disclosure within a range that does not conflict with the other proposed method(s).

### [Proposed Method 03]

A base station may instruct periodic CSI reporting to a terminal through higher-layer signaling such as RRC signaling. When periodic CSI reporting is activated, the terminal may periodically report channel information according to a configured slot interval. When periodic CSI reporting is deactivated, the terminal may stop the periodic channel information reporting operation that has been activated. When the base station instructs aperiodic CSI reporting or semi-persistent CSI reporting to the terminal through DCI, medium access control (MAC)-control element (CE), or the like, the base station and the terminal may determine whether the terminal is capable of performing valid channel reporting through the instructed CSI reporting in consideration of a CSI computation time required for CSI reporting.

For example, the terminal may perform valid CSI reporting starting from an uplink symbol after Z symbols from an end of a last symbol of a PDCCH including DCI instructing CSI reporting. In other words, a CPU may maintain an occupied state from a first OFDM symbol after PDCCH triggering to a last symbol of a PUSCH carrying a CSI report. Z may vary according to numerology of a downlink bandwidth part for the PDCCH, numerology of an uplink bandwidth part for the PUSCH carrying the CSI report, or a type or a characteristic of channel information reported by the CSI report.

In addition, when a reference signal for channel measurement for aperiodic CSI reporting instructed to the terminal through DCI is an aperiodic reference signal, the terminal may perform valid CSI reporting starting from an uplink symbol after Z symbols from an end of a last symbol including the reference signal. In other words, a CPU may maintain an occupied state from a time at which the terminal receives a measurement resource related to CSI reporting (e.g. a resource in which CSI-RS is transmitted) to a time at which the terminal actually performs CSI reporting.

The terminal may perform valid CSI reporting starting from a first uplink symbol satisfying both a time after Z symbols from an end of a last symbol of the PDCCH including DCI and a time after Z′ symbols from an end of a last symbol including the reference signal. When a CSI reporting time indicated by the base station does not satisfy a requirement for CSI computation time, the terminal may not consider a channel information state update for valid CSI reporting. For example, when a time interval configured for CSI reporting is shorter than Z or Z′ that is preconfigured by the terminal, the terminal may not perform CSI reporting or may transmit a CSI report by filling the corresponding position with arbitrary bits.

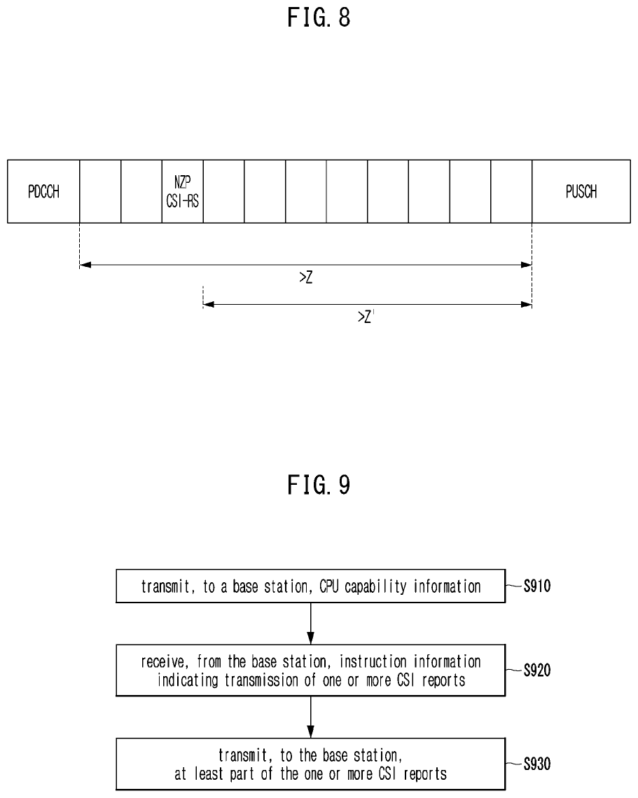

FIG. 8 is a conceptual diagram for describing an example to which Proposed Method 03 according to an exemplary embodiment of the present disclosure is applied.

Referring to FIG. 8, a terminal may receive or monitor a PDCCH. Here, the PDCCH may be a channel through which DCI instructing CSI reporting is transmitted. The terminal may determine a last symbol in which the PDCCH is transmitted. Here, the terminal may perform valid CSI reporting in an uplink symbol after Z symbols from the last symbol, that is, in an uplink symbol spaced apart by a time interval corresponding to Z symbols from the last symbol. In addition, based on a last symbol among one or more symbols in which a reference signal for channel measurement for CSI reporting instructed to the terminal through DCI is transmitted, the terminal may perform valid CSI reporting in an uplink symbol after Z′ symbols, that is, in an uplink symbol spaced apart by a time interval corresponding to Z′ symbols from the last symbol among the one or more symbols in which the reference signal is transmitted.

FIG. 8 illustrates an example in which a time-domain resource in which the terminal performs CSI reporting through a PUSCH is determined on a first uplink symbol after a symbol spaced apart by a time interval corresponding to Z symbols from a last symbol on which the PDCCH is transmitted. Here, the first uplink symbol may be identical to a first uplink symbol after a symbol spaced apart by a time interval corresponding to Z′ symbols from a last symbol among one or more symbols in which a reference signal for channel measurement for CSI reporting instructed to the terminal through DCI is transmitted.

Meanwhile, in the example of FIG. 8, a symbol is used as a unit of a time-domain resource through which a channel, a reference signal, or the like are transmitted. However, the example of FIG. 8 may be applied to various time-domain resource units defined in a next-generation wireless communication system, such as a symbol, a slot, a subframe, or the like.

The information on Z and Z′ related to the above-described CSI computation time may be determined as values as shown in Table 1 below. For example, when channel information reported in CSI reporting includes only wideband information, a number of ports for the reference signal is 4 or less, and a report quantity is ‘cri-RI-CQI’, Z and Z′ may take values of Z₁ and Z′₁. As another example, when a report quantity is ‘cri-RSRP’ or ‘ssb-Index-RSRP’, Z and Z′ symbols may take values of Z₃ and Z′₃. In this case, X1, X2, X3, X5, and X6 indicate a terminal capability for a beam reporting time, and KB1, KB2, KB3, and KB4 indicate a terminal capability for a beam switching time. Information related to CSI computation time may be included in UE capability information and may be reported to the base station by the terminal.

TABLE 1

| | Z₁ [symbols] | | Z₂ [symbols] | | Z₃ [symbols] | |
|---|---|---|---|---|---|---|
| μ | Z₁ | Z′₁ | Z₂ | Z′₂ | Z₃ | Z′₃ |
| 0 | 22 | 16 | 40 | 37 | 22 | X₀ |
| 1 | 33 | 30 | 72 | 69 | 33 | X₁ |
| 2 | 44 | 42 | 141 | 140 | min(44, X₂ + KB₁) | X₂ |
| 3 | 97 | 85 | 152 | 140 | $min ( 97 , {X}_{3} + {KB}_{2} )$ | X₃ |
| 5 | 388 | 340 | 608 | 560 | $min ( 388 , X 5 + KB 3 )$ | X5 |
| 6 | 776 | 680 | 1216 | 1120 | $min ( 776 , X 6 + KB 4 )$ | X6 |

When the terminal performs intelligent CSI reporting, an inference time for an intelligent function or model used by the terminal may be included in a CSI computation time. The terminal may calculate a minimum inference time required in a process of operating the intelligent function, and the terminal may calculate the required time based on a time at which a request for an inference operation is received or based on a time at which a reference signal for the inference operation is received and may inform the base station of the required time in advance. The information may be expressed as X_{inf}, and the information may be reported to the base station by the terminal through UE capability information. The base station may utilize the minimum inference time reported by the terminal to calculate Z and Z′.

In addition, instead of the method in which the terminal directly reports inference time information and the inference time information is utilized, a method may be used in which the terminal is classified into a normal UE and an advanced UE according to the capability for supporting the intelligent function. Accordingly, CSI computation time for intelligent CSI reporting may be differentially applied according to the terminal performance. The terminal may configure its capability such that terminal supports one of a normal terminal and an advanced terminal, and the terminal may report the terminal capability to the base station.

The above Proposed Method 03 may be applied together with other proposed method(s) of the present disclosure within a range that does not conflict with the other proposed method(s).

### [Proposed Method 04]

A CSI priority rule used in a CSI reporting process may be determined through priority values as shown in Table 2 below. The CSI priority value may be determined based on a type of channel information included in a CSI report, a time-domain reporting characteristic of CSI reporting, a type of channel through which the CSI report is transmitted, a serving cell index, a CSI report configuration index, and the like. The base station or the terminal may determine that a CSI report having a smaller priority value has a higher CSI priority through comparison of priority values.

TABLE 2

CSI priority value Pri_{iCSI}(y, k, c, s) =
2 · N_{cells} · Mₛ · y + N_{cells} · Mₛ · k + Mₛ · c + s
y = 0: aperiodic CSI report transmitted on PUSCH
y = 1: semi-persistent CSI report transmitted on PUSCH
y = 2: semi-persistent CSI report transmitted on PUCCH
y = 3: periodic CSI report transmitted on PUCCH
k = 0: when the CSI report includes L1-RSRP or L1-SINR
k = 1: when the CSI report does not include L1-RSRP or L1-SINR
c: serving cell index
N_{cells}: maximum number of serving cells configured
by higher-layer signaling
s: index of the CSI report configuration (reportConfigID)
Mₛ: maximum number of CSI report configurations
configured by higher-layer signaling

When the terminal performs intelligent CSI reporting, additional conditions to be considered in the above-described CSI priority rule may exist. A procedure for performing intelligent CSI reporting during operation of an intelligent function may be divided into an inference process, a performance monitoring process, and a data collection process. The inference operation means that an inference result obtained from an intelligent model is delivered through a CSI report, and the inference operation may have the highest priority because the inference operation affects a subsequent operation of the base station. A CSI report for performance monitoring means a CSI report carrying a performance metric or a measurement result for performance metric calculation, and may be used to evaluate performance of the intelligent model. Although performance evaluation of the intelligent model is continuously performed, it is not a time critical operation, and thus a CSI report related to performance monitoring may have a relatively lower priority than a CSI report related to the inference operation. Lastly, a CSI report for data collection may mean that a measurement result is delivered through CSI reporting for an intelligent operation or model training, or CSI reporting for data collection may mean a process of receiving a reference signal for data collection and calculating required information without actual CSI reporting. A data collection process is performed over a long time series and does not require a fast response, and thus a CSI report for data collection may have a relatively lowest priority when compared with other intelligent CSI reports.

For example, a rule for the ‘k’ variable may be added in the above-described priority rule. An inference operation using an intelligent model means that a CSI report includes an inference result, and in this case, K may be set to 0 to increase priority. The performance monitoring operation means that a CSI report includes a performance metric or a measurement result for performance metric calculation, and in this case, K may be set to 1 to adjust priority, or K may be set to 2 to lower priority than other CSI reports. Similarly, a CSI report for data collection may also set K to 1 to adjust priority, or may set K to 2 to assign a lower priority than other CSI reports.

The above Proposed Method 04 may be applied together with other proposed method(s) of the present disclosure within a range that does not conflict with the other proposed method(s).

### [Proposed Method 05]

During operation of the above-described intelligent CPU, when available intelligent CPUs (i.e. CPU_{AIML}) are insufficient or a requirement for CSI computation time is not satisfied, a terminal may not perform a channel information state update for valid CSI reporting. In this case, with respect to an uplink resource already allocated for CSI reporting, the terminal may not perform corresponding reporting, may transmit by leaving the corresponding position (or a corresponding resource of the position) empty, or may transmit by filling arbitrary dummy information in the corresponding position. Alternatively, instead of transmitting arbitrary dummy information in the corresponding location, in order to inform a reason why intelligent CSI reporting has failed, the terminal may additionally transmit a reason code expressed by specific bits in the uplink resource already allocated for CSI reporting. In addition, since a case in which only a part of CSI reporting fails rather than the entire CSI reporting may occur, the terminal may also deliver information indicating a partial failure of CSI reporting to the base station by adding the information to a position (or a resource) corresponding to a failed part.

As another method, when intelligent CSI reporting has failed but the same operation can be performed through legacy CSI reporting, the terminal may perform a legacy operation and may perform the legacy operation and transmit the resulting information. For example, when the terminal performs intelligent CSI prediction but the terminal is incapable of performing intelligent CSI prediction due to insufficiency of intelligent processing units, the terminal may perform a legacy CSI prediction operation not using an intelligent unit, and may deliver a result of the legacy CSI prediction operation by transmitting the result through the uplink resource. In this case, the terminal may additionally deliver information or an indicator indicating that corresponding channel information is generated through a legacy operation rather than an intelligent operation.

The above Proposed Method 05 may be applied together with other proposed method(s) of the present disclosure within a range that does not conflict with the other proposed method(s).

Each of the plurality of proposed methods described so far is not independent from the other proposed methods but is interrelated with them. For example, a technical element belonging to one proposed method may be combined with a technical element belonging to another proposed method to form a new proposed method, and such a new proposed method is also included in various exemplary embodiments of the present disclosure. As described above, a technical constituent element selected in one proposed method and a technical constituent element selected in another proposed method may be combined to constitute an exemplary embodiment as follows.

FIG. 9 is a flow chart for describing an example of operations performed by a terminal according to an exemplary embodiment of the present disclosure.

Referring to FIG. 9, a terminal transmits CPU capability information to a base station (S910). Here, the CPU capability information may include information regarding a number of CPUs that the terminal is capable of simultaneously using (or information regarding CSI processing capacity or resources that the terminal is capable of simultaneously using for CSI calculation).

The terminal may receive instruction information indicating transmission of one or more CSI reports from the base station (S920). Here, the base station may consider the CPU capability information when generating the instruction information. In addition, a number of CPUs required for the one or more CSI reports may be a total number of CPUs required for each of the one or more CSI reports.

The terminal transmits at least part of the one or more CSI reports to the base station based on the instruction information (S930). Here, when a number of CSI reports that the terminal is capable of processing is smaller than a number of the one or more CSI reports for which transmission is instructed, the terminal may transmit CSI reports corresponding to the number of CSI reports that the terminal is capable of processing to the base station, and the terminal may not update channel information for CSI reports corresponding to a value obtained by subtracting the number of CSI reports that the terminal is capable of processing from the number of the one or more CSI reports for which transmission is instructed. In this case, CSI reports not updated or channel information associated with the CSI reports may be determined based on at least a part of importance of channel information, priority, a length of channel information computation time, and a length of CPU occupation time.

In addition, CPUs may be classified into normal CPU(s) and intelligent CPU(s) (e.g. CPU(s) for CSI reporting in which an AI/ML model is used). In other words, operations of FIG. 9 may be performed for a normal CPU and for an intelligent CPU. Accordingly, Accordingly, the terminal may perform the procedure of FIG. 9 with respect to both the normal CPU and the intelligent CPU.

At least some of Proposed Methods 01 to 05 described through the present disclosure may be applied to the procedure of FIG. 9. For example, when determining a number of CPUs, a time at which an intelligent operation is performed and complexity of an AI/ML model used in the intelligent operation may be considered. In addition, when the terminal and/or the base station determines a time-domain resource through which a CSI report is transmitted, the time-domain resource may be determined as a first uplink time-domain resource that is spaced apart by Z symbols as in Proposed Method 03 from a time-domain resource through which instruction information is transmitted and is simultaneously spaced apart by Z′ symbols as in Proposed Method 03 from a time-domain resource through which a reference signal for CSI reporting is transmitted. In addition, a priority for determining CSI reports not updated may also be determined as in Proposed Method 04. In addition, based on Proposed Method 05, in a resource allocated for CSI reports not updated, the terminal may leave the allocated resource empty, may not transmit CSI reports not updated, or may transmit arbitrary dummy information. Furthermore, since at least a part of methods proposed in the present disclosure may be applied to the procedure of FIG. 9, a redundant description is omitted for brevity.

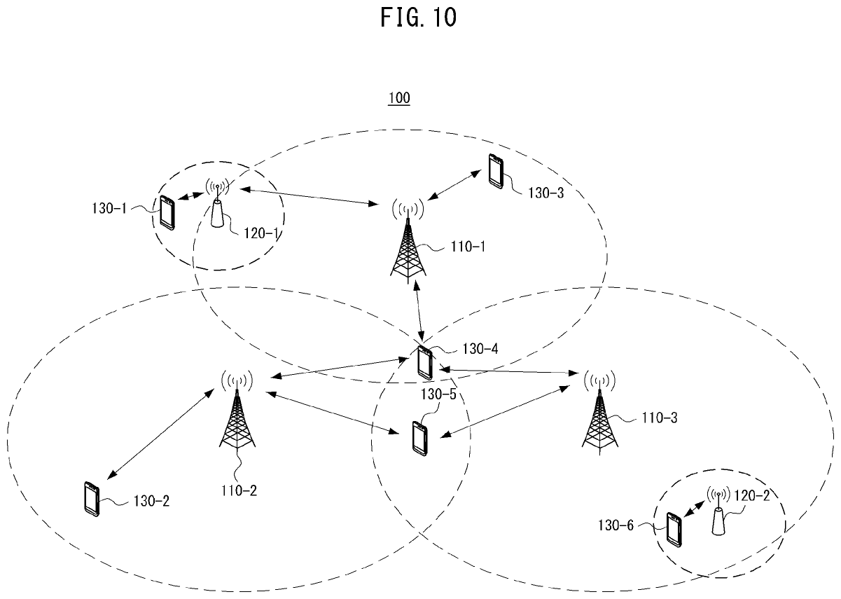

FIG. 10 is a conceptual diagram for describing a first exemplary embodiment of a mobile communication system.

Referring to FIG. 10, a communication system 100 may include a plurality of communication nodes 110-1, 110-2, 110-3, 120-1, 120-2, 130-1, 130-2, 130-3, 130-4, 130-5, and 130-6. The plurality of communication nodes may support 4G communication (e.g. long term evolution (LTE) and LTE-Advanced (LTE-A)), 5G communication (e.g. new radio (NR)), and the like defined as 3rd generation partnership project (3GPP) standards. The 4G communication may be performed in a frequency band of 6 GHz or below, and the 5G communication may be performed not only in a frequency band of 6 GHz or below but also in a frequency band of 6 GHz or above.

For example, for 4G communication and 5G communication, a plurality of communication nodes may support a communication protocol based on code division multiple access (CDMA), a communication protocol based on wideband CDMA (WCDMA), a communication protocol based on time division multiple access (TDMA), a communication protocol based on frequency division multiple access (FDMA), a communication protocol based on orthogonal frequency division multiplexing (OFDM), a communication protocol based on Filtered OFDM, a communication protocol based on cyclic prefix (CP)-OFDM, a communication protocol based on discrete Fourier transform-spread-OFDM (DFT-s-OFDM), a communication protocol based on orthogonal frequency division multiple access (OFDMA), a communication protocol based on single carrier-FDMA (SC-FDMA), non-orthogonal multiple access (NOMA), a communication protocol based on generalized frequency division multiplexing (GFDM), a communication protocol based on filter bank multi-carrier (FBMC), a communication protocol based on universal filtered multi-carrier (UFMC), a communication protocol based on space division multiple access (SDMA), and the like.

In addition, the communication system 100 may further include a core network. When the communication system 100 supports 4G communication, the core network may include a serving gateway (S-GW), a packet data network gateway (P-GW), a mobility management entity (MME), and the like. When the communication system 100 supports 5G communication, the core network may include a user plane function (UPF), a session management function (SMF), an access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have a structure as follows. In addition, as an example, the above-described communication system 100 may be applied not only to 5G communication but also to a next-generation communication system (e.g. 6G communication system), and the communication system 100 is not limited to a specific form.

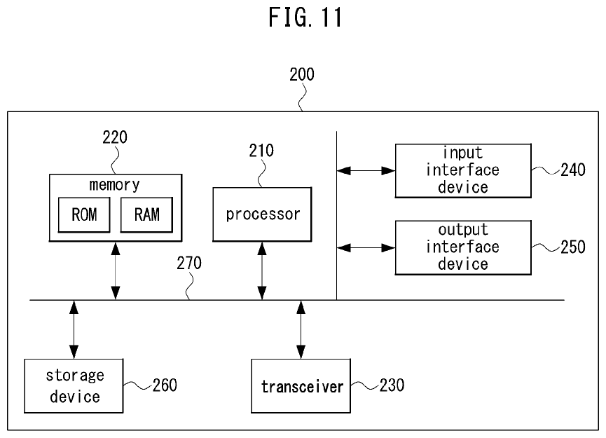

FIG. 11 is a block diagram for describing a first exemplary embodiment of a communication node constituting a communication system.

Referring to FIG. 11, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 10, the communication system 100 may include a plurality of base stations 110-1, 110-2, 110-3, 120-1, and 120-2 and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an “access network”. The first base station 110-1, the second base station 110-2, and the third base station 110-3 may each form a macro cell. The fourth base station 120-1 and the fifth base station 120-2 may each form a small cell. The fourth base station 120-1, the third terminal 130-3, and the fourth terminal 130-4 may belong to cell coverage of the first base station 110-1. The second terminal 130-2, the fourth terminal 130-4, and the fifth terminal 130-5 may belong to cell coverage of the second base station 110-2. The fifth base station 120-2, the fourth terminal 130-4, the fifth terminal 130-5, and the sixth terminal 130-6 may belong to cell coverage of the third base station 110-3. The first terminal 130-1 may belong to cell coverage of the fourth base station 120-1. The sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), base transceiver station (BTS), radio base station, radio transceiver, access point, access node, road side unit (RSU), digital unit (DU), cloud digital unit (CDU), radio remote head (RRH), radio unit (RU), transmission point (TP), transmission and reception point (TRP), relay node, or the like. Each of the plurality of terminals 130-1, 130-2, 130-3, 130-4, 130-5, and 130-6 may refer to a terminal, access terminal, mobile terminal, station, subscriber station, mobile station, portable subscriber station, node, device, or the like.

Meanwhile, each of the plurality of base stations 110-1, 110-2, 110-3, 120-1, and 120-2 may operate in a different frequency band, or may operate in the same frequency band. Each of the plurality of base stations 110-1, 110-2, 110-3, 120-1, and 120-2 may be connected to each other through an ideal backhaul link or a non-ideal backhaul link, and may exchange information with each other through the ideal backhaul link or the non-ideal backhaul link. Each of the plurality of base stations 110-1, 110-2, 110-3, 120-1, and 120-2 may be connected to a core network through the ideal backhaul link or the non-ideal backhaul link. Each of the plurality of base stations 110-1, 110-2, 110-3, 120-1, and 120-2 may transmit signals received from the core network to the corresponding terminals 130-1, 130-2, 130-3, 130-4, 130-5, and 130-6, and may transmit signals received from the corresponding terminals 130-1, 130-2, 130-3, 130-4, 130-5, and 130-6 to the core network.

Various exemplary embodiments of the present disclosure may be implemented through hardware, firmware, software, or a combination thereof. In the case of hardware implementation, the various exemplary embodiments of the present disclosure may be implemented using one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), general processors, controllers, microcontrollers, or microprocessors.

The scope of the present disclosure includes software or machine-executable instructions (e.g. operating systems, applications, firmware, programs, etc.) that allow operations according to the methods of various exemplary embodiments to be executed on a device or computer, as well as non-transitory computer-readable media in which such software or instructions are stored and executable on a device or computer. Examples of computer-readable media include hardware devices specifically configured to store and execute program instructions, such as ROM, RAM, and flash memory. Examples of program instructions include not only machine code generated by a compiler but also high-level language code that can be executed by a computer using an interpreter or similar methods. The aforementioned hardware devices may be configured to operate as at least one software module to perform the operations of the present disclosure, and vice versa.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

The claims described in the present disclosure may be combined in various ways. For example, technical features of method claims of the present disclosure may be combined and implemented as an apparatus, and technical features of apparatus claims of the present disclosure may be combined and implemented as a method. In addition, technical features of method claims of the present disclosure and technical features of apparatus claims of the present disclosure may be combined and implemented as an apparatus, and technical features of method claims of the present disclosure and technical features of apparatus claims of the present disclosure may be combined and implemented as a method. Furthermore, exemplary embodiments described in the present disclosure may be combined within a scope in which the exemplary embodiments do not conflict with each other.

What is claimed is:

1. A method performed by a terminal in a mobile communication system, the method comprising:
transmitting, to a base station, channel state information (CSI) processing unit (CPU) capability information, the CPU capability information including information on a number of CPUs that the terminal is capable of simultaneously using;
receiving, from the base station, instruction information indicating transmission of one or more CSI reports; and
transmitting, to the base station, at least part of the one or more CSI reports based on the instruction information,
wherein the terminal transmits CSI reports corresponding to a second number to the base station based on a determination that the second number of CSI reports that the terminal is capable of processing is smaller than a first number of the one or more CSI reports for which transmission is indicated, and the terminal does not update channel information for CSI reports corresponding to a value obtained by subtracting the second number from the first number, and
wherein the terminal transmits the one or more CSI reports to the base station based on a determination that the second number is equal to or greater than the first number.

2. The method of claim 1,
wherein whether channel information is updated is determined based on at least one of importance, priority, a channel information calculation time, or a CPU occupation time of the channel information.

3. The method of claim 1,
wherein the first number is determined based on the number of CPUs that the terminal is capable of simultaneously using.

4. The method of claim 1,
wherein the CPUs include normal CPU(s) and intelligent CPU(s), each of the intelligent CPU(s) is a CPU in which an artificial intelligence model is used for CSI reporting, and the number of CPUs indicated through the CPU capability information includes a third number corresponding to the normal CPU(s) and a fourth number corresponding to the intelligent CPU(s).

5. The method of claim 4,
wherein the transmitting of the at least part of the one or more CSI reports is independently performed by the terminal based on the third number and the fourth number.

6. The method of claim 4,
wherein the fourth number of the intelligent CPU(s) is determined based on complexity of an artificial intelligence model used by the terminal.

7. The method of claim 1,
wherein a time-domain resource in which the terminal transmits the at least part of the one or more CSI reports to the base station is a first uplink time-domain resource among time-domain resources that are spaced apart by at least a first time interval from a first time-domain resource in which the terminal receives the instruction information and are spaced apart by at least a second time interval from a second time-domain resource in which the terminal receives a reference signal for the at least part of the one or more CSI reports.

8. A terminal comprising:
one or more memories configured to store instructions;
one or more transceivers; and
one or more processors configured to execute the instructions to perform:
transmitting, to a base station, channel state information (CSI) processing unit (CPU) capability information, the CPU capability information including information on a number of CPUs that the terminal is capable of simultaneously using;
receiving, from the base station, instruction information indicating transmission of one or more CSI reports; and
transmitting, to the base station, at least part of the one or more CSI reports based on the instruction information,
wherein the terminal transmits CSI reports corresponding to a second number to the base station based on a determination that the second number of CSI reports that the terminal is capable of processing is smaller than a first number of the one or more CSI reports for which transmission is indicated, and the terminal does not update channel information for CSI reports corresponding to a value obtained by subtracting the second number from the first number, and
wherein the terminal transmits the one or more CSI reports to the base station based on a determination that the second number is equal to or greater than the first number.

9. The terminal of claim 8,
wherein whether channel information is updated is determined based on at least one of importance, priority, a channel information calculation time, or a CPU occupation time of the channel information.

10. The terminal of claim 8,
wherein the first number is determined based on the number of CPUs that the terminal is capable of simultaneously using.

11. The terminal of claim 8,
wherein the CPUs include normal CPU(s) and intelligent CPU(s), each of the intelligent CPU(s) is a CPU in which an artificial intelligence model is used for CSI reporting, and the number of CPUs indicated through the CPU capability information includes a third number corresponding to the normal CPU(s) and a fourth number corresponding to the intelligent CPU(s).

12. The terminal of claim 11,
wherein the transmitting of the at least part of the one or more CSI reports is independently performed by the terminal based on the third number and the fourth number.

13. The terminal of claim 11,
wherein the fourth number of the intelligent CPU(s) is determined based on complexity of an artificial intelligence model used by the terminal.

14. The terminal of claim 8, wherein
wherein a time-domain resource in which the terminal transmits the at least part of the one or more CSI reports to the base station is a first uplink time-domain resource among time-domain resources that are spaced apart by at least a first time interval from a first time-domain resource in which the terminal receives the instruction information and are spaced apart by at least a second time interval from a second time-domain resource in which the terminal receives a reference signal for the at least part of the one or more CSI reports.

15. A non-transitory computer-readable medium storing instructions executable by at least one processor included in a terminal, the instructions causing the terminal to perform:
transmitting, to a base station, channel state information (CSI) processing unit (CPU) capability information, the CPU capability information including information on a number of CPUs that the terminal is capable of simultaneously using;
receiving, from the base station, instruction information indicating transmission of one or more CSI reports; and
transmitting, to the base station, at least part of the one or more CSI reports based on the instruction information,
wherein the terminal transmits CSI reports corresponding to a second number to the base station based on a determination that the second number of CSI reports that the terminal is capable of processing is smaller than a first number of the one or more CSI reports for which transmission is indicated, and the terminal does not update channel information for CSI reports corresponding to a value obtained by subtracting the second number from the first number, and
wherein the terminal transmits the one or more CSI reports to the base station based on a determination that the second number is equal to or greater than the first number.

16. The non-transitory computer-readable medium of claim 15,
wherein whether channel information is updated is determined based on at least one of importance, priority, a channel information calculation time, or a CPU occupation time of the channel information.

17. The non-transitory computer-readable medium of claim 15,
wherein the first number is determined based on the number of CPUs that the terminal is capable of simultaneously using.

18. The non-transitory computer-readable medium of claim 15,
wherein the CPUs include normal CPU(s) and intelligent CPU(s), each of the intelligent CPU(s) is a CPU in which an artificial intelligence model is used for CSI reporting, and the number of CPUs indicated through the CPU capability information includes a third number corresponding to the normal CPU(s) and a fourth number corresponding to the intelligent CPU(s).

19. The non-transitory computer-readable medium of claim 18,
wherein the transmitting of the at least part of the one or more CSI reports is independently performed by the terminal based on the third number and the fourth number.

20. The non-transitory computer-readable medium of claim 15,
wherein a time-domain resource in which the terminal transmits the at least part of the one or more CSI reports to the base station is a first uplink time-domain resource among time-domain resources that are spaced apart by at least a first time interval from a first time-domain resource in which the terminal receives the instruction information and are spaced apart by at least a second time interval from a second time-domain resource in which the terminal receives a reference signal for the at least part of the one or more CSI reports.
